(19) United States
(12) Patent Application Publication
(10) Pub. No.: US 2007/0015404 A1
(43) Pub. Date: Jan. 18, 2007

(54) Filtered electrical connector

(75) Inventor: John S. Shisler, Mesa, AZ (US)

Correspondence Address: OLIFF & BERRIDGE, PLC, P.O. BOX 19928, ALEXANDRIA, VA, 22320, US

(73) Assignee: Radiall, Rosny Sous Bois (FR)

(21) Appl. No.: 11/180,569

(22) Filed: Jul. 14, 2005

(51) Int. Cl. H01R 13/73

(52) U.S. Cl. 439/544

(57) ABSTRACT

The present invention concerns a filtered electrical connector comprising: a connector housing presenting front and rear faces and defining at least one cavity opening into its front and rear faces; a filter assembly arranged to be put into place removably in said cavity and having a plurality of electrical contact elements, each provided with at least one pin; and front and rear assemblies arranged to be put into place removably in said cavity on either side of the filter assembly so as to protect the filter assembly from the external environment, at least one of the front and rear assemblies comprising an insulating insert together with electrical contact elements secured to the insulating insert and co-operating with the electrical contact elements of the filter assembly when the connector is assembled.

The present invention relates to a filtered electrical connector.

### BACKGROUND OF THE INVENTION

U.S. Pat. No. 4,729,743 discloses a filtered electrical connector including a filter subassembly put into place in a cavity in a connector housing. A dielectric adhesive material is placed on the front and rear faces of the cavity in order to protect the filter subassembly from humidity and corrosion. The filter subassembly has electrical contact pins extending through the adhesive material.

For that known type of connector, the operation of detecting a defect in an interface is performed at the end of the assembly line, and in the result of a defect being found, that can lead to the entire connector being rejected as a whole, and thus to an increase in production costs.

Furthermore, depositing insulating material, e.g. constituted by an epoxy resin, is itself an operation that can present certain difficulties, associated in particular with the electrical contact pins being soiled or with the ability of the insulating material to withstand high levels of thermal stress that might degrade its sealing properties.

Other constructions for a filtered connector are also known from U.S. Pat. Nos. 5,236,376 and 5,647,766, and from European patent application No. 1 538 717.

### OBJECTS AND SUMMARY OF THE INVENTION

The invention provides a filtered electrical connector comprising:
a connector housing presenting front and rear faces and defining at least one cavity opening into said front and rear faces;
a filter assembly arranged to be put into place, in particular in removable manner, in said cavity, and having a plurality of electrical contact elements; and
front and rear assemblies arranged to be put into place, in particular in removable manner, in said cavity, on either side of the filter assembly, so as to protect the filter assembly from the external environment.

Each electrical contact element of the filter assembly may be provided with at least one pin.

Advantageously, at least one of the front and rear assemblies includes an insulating insert and electrical contact elements secured to the insulating insert and co-operating with the electrical contact elements of the filter assembly once the connector is assembled.

The invention enables the filter assembly to be protected from the external environment, in particular against humidity or dust, without requiring an operation of depositing an epoxy resin in the cavity of the housing.

This enables assembly and maintenance of the connector of the invention to be simplified.

Preferably, at least one of the front and rear assemblies is a one-piece assembly.

The invention enables a filtered connector to be obtained that is of modular type.

For example, a single connector housing of the invention can be assembled on demand with front and rear assemblies of different types.

In an embodiment of the invention, the insert of the front or rear assembly includes orifices, and at least one of the contact elements of said front or rear assembly can be inserted by force in an orifice of the insert.

At least one of the front and rear assemblies may include at least one contact element provided with a recess in which at least part of the pin of a contact element of the filter assembly can be engaged.

Once the connector is assembled, the contact elements of the filter assembly may, where appropriate, remain set back from a rear face of the rear assembly and/or a front face of the front assembly.

In an embodiment of the invention, once assembly is complete, the filter assembly is received entirely within the cavity of the housing.

At least one of the front and rear assemblies may be held to the connector housing by snap-fastening or with the help of at least one fitting, such as a snap ring.

Advantageously, the connector includes at least one sealing gasket, in particular an O-ring, disposed around at least one of the front and rear assemblies and pressing against a wall of the cavity.

The presence of a sealing gasket serves to ensure satisfactory sealing without it being necessary to deposit any resin.

The gasket may present resistance to high temperature so that its properties are affected little or not at all, e.g. when performing soldering operations on the connector.

In addition, the use of a sealing gasket makes it easy to replace the front or rear assembly.

In an embodiment of the invention, the connector includes at least one layer made of compressible material that is interposed between the filter assembly and one of the front and rear assemblies.

This layer enables the various assemblies to be mounted without play in the cavity of the housing so as to protect the connector against possible vibration while the connector is in use.

In an embodiment of the invention, the filter assembly includes a ground element preferably defining at least part of a side wall of the filter assembly and arranged to press against a wall of the cavity of the housing.

This ground element may comprise, for example, an elastically deformable belt.

The ground element may apply a certain amount of stress against the wall of the cavity of the housing so as to ensure satisfactory ground continuity.

Advantageously, at least one of the front and rear assemblies includes a keying element arranged to co-operate with the housing to prevent the front or rear assembly from turning relative to the housing at the end of assembly.

In an embodiment of the invention, the front assembly, respectively the rear assembly, is configured for being mounted on the housing through the front face, respectively the rear face, thereof.

In a variant, the filter assembly and the front and rear assemblies are configured for being mounted on the housing through a same mounting face, for instance the front or rear face of the housing.

For instance, the housing may comprise a stop situated in particular opposite the mounting face for retaining at least one of the front and rear assemblies in the cavity.

The connector thus may comprise retention means for retaining the filter assembly and the front and rear assemblies in the cavity of the housing, said retention means being disposed only in the proximity of the mounting face.

The retention means may comprise for instance at least one snap-fastening element.

The filter assembly may comprise filter elements selected from: capacitive type filters; chip diodes; and Pi type filters.

At least one of the contact elements of the rear assembly may be arranged to be capable of being soldered to a printed circuit card or to enable an electric wire of a cable to be soldered thereto.

The contact elements of the front assembly, which may be of male or of female type, are arranged to co-operate with contact elements of a complementary connector.

The invention also provides a method of assembling a filtered electrical connector, the connector comprising:
a connector housing presenting front and rear faces and defining at least one cavity opening into its front and rear faces;
a filter assembly arranged to be put into place removably in said cavity and having a plurality of electrical contact elements, each provided with at least one pin; and
front and rear assemblies arranged to be put into place removably in said cavity on either side of the filter assembly, at least one of the front and rear assemblies comprising an insulating insert together with electrical contact elements secured to the insulating insert and co-operating with the electrical contact elements of the filter assembly when the connector is assembled,
   the method comprising the following steps:
fastening the contact elements to the insert of the front or rear assembly, in particular by force; and
introducing said front or rear assembly into the cavity of the housing.

The method may also include the following step:
prior to mounting on the connector housing, inspecting the interface between the filter assembly and at least one of the front and rear assemblies.

### BRIEF DESCRIPTION OF THE DRAWINGS

The present invention can be better understood on reading the following detailed description of non-limiting embodiments of the invention, and on examining the accompanying drawings, in which:

FIG. 1 is a diagrammatic and fragmentary section view of a filtered connector of the invention;

FIG. 2 is a diagrammatic and fragmentary section view of a connector constituting a variant embodiment of the invention;

FIG. 3 is a rear view of the FIG. 1 connector;

FIG. 4 is a side view of the rear assembly of the FIG. 1 connector;

FIG. 5 is a diagrammatic and fragmentary view of a filter assembly of the FIG. 1 connector; and

FIG. 6 is a side view of the FIG. 5 filter assembly.

### MORE DETAILED DESCRIPTION

FIG. 1 shows a filtered electrical connector 1 of the modular type in accordance with the invention, comprising a housing 2, a filter assembly 3, and front and rear assemblies 4 and 5.

In the example described, the connector 1 is of the circular type.

In a variant, the connector 1 could be of the rectangular type.

The connector 1 may be used in particular in the field of equipment on board aircraft.

The housing 2 has front and rear faces 7 and 8, and it defines a cavity 9 that opens out in said front and rear faces 7 and 8.

The connector 1 may present a single cavity 9, or a plurality of cavities, each receiving a respective filter assembly 3.

The housing 2 may include a flange 10 enabling it to be fastened to a panel fitted to a rack or a cabinet.

The housing 2 is made of an electrically conductive material, e.g. aluminum.

The filter assembly 3 serves to protect electronic equipment against parasitic electromagnetic interference or against electrostatic discharge.

In the example described, the filter assembly 3 comprises two plane substrates 12 of circular section, as shown in FIG. 5, placed parallel to each other and having filter elements 13 placed between them and/or on them.

The filter element may be selected, for example, amongst filters of capacitive type, diodes in the form of chips, or Pi type filters, this list not being limiting.

The filter assembly 3 may define, for example, a filter of LC (inductive and capacitive) type.

The substrates 12 may be based in particular on a ceramic.

The filter assembly 3 includes a ground element constituted by an elastically deformable belt 15 made of an electrically conductive material, as shown in FIG. 6 in particular.

This belt 15 presses against a wall 16 of the cavity 9 when the filter assembly 3 is put into place in the cavity 9.

The filter assembly 3 further comprises a plurality of contact elements 17 each formed by a pin held in orifices 18 formed in the substrates 12.

The filter assembly 3 is fully received within the cavity 9 of the housing 2.

The front assembly 4 comprises firstly an insulating insert 20 provided with a plurality of orifices 21, the insert 20 optionally being made of plastics material, for instance PPS.

The front assembly 4 further comprises a plurality of contact elements 22, each inserted by force into a respective orifice 21 of the insert 20.

Each contact element 22 presents a recess 23 into which an end of a pin 17 of the filter assembly 3 is inserted.

In the embodiment shown in FIG. 1, the contact elements 22 are of the male type.

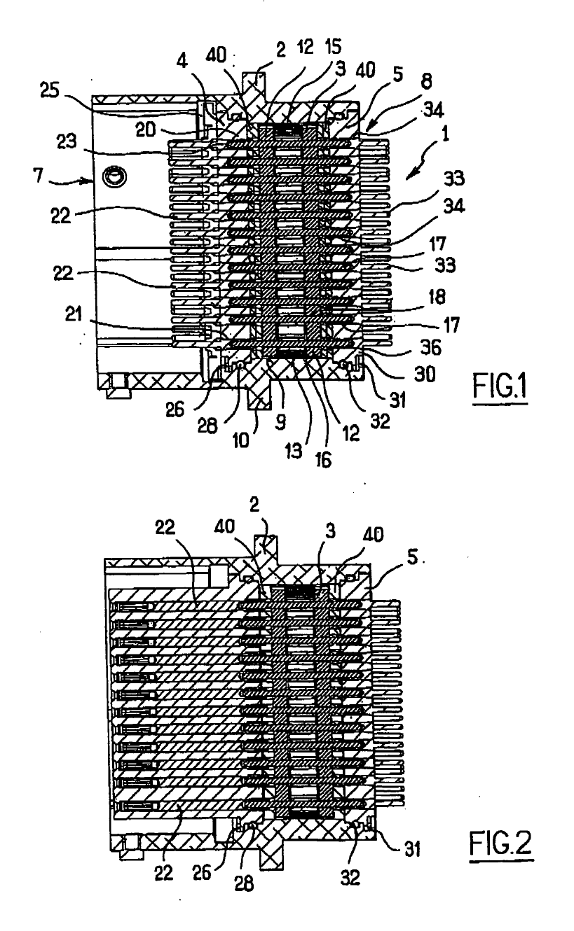

In a variant, and as shown in FIG. 2, the contact element 22 can be of the female type.

The pins 17 of the filter assembly remain set back from a front face 25 of the front assembly 4.

When the front assembly 4 is put into place in the cavity 9, this assembly 4 forms peripheral and interfacial joints.

The assembly 4 is held in the cavity 9, e.g. by means of a snap ring 26.

In a variant, the assembly 4 may be held in the cavity 9 by snap-fastening.

A sealing gasket in the form of an O-ring 28 is disposed between the front assembly 4 and the wall 16 defining the cavity 9.

Like the front assembly 4, the rear assembly 5 comprises an insulating insert 30 held in the cavity 9 by a snap ring 31, a sealing O-ring 32 being interposed between the rear assembly 5 and the wall 16 defining the cavity 9.

The rear assembly 5 has a plurality of contact elements 33 inserted by force in respective orifices 34 of the insert 30.

The contact elements 33 have recesses 34, each of which has one end of a pin 17 of the filter assembly inserted therein.

The pins 17 remain set back from a rear face 36 of the rear assembly 5.

The contact elements 33 may be arranged so as to be suitable for being soldered to a printed circuit card, or so as to allow electric wires to be soldered thereto.

As can be seen, the front and rear assemblies 4 and 5 form respective one-piece assemblies, each capable of being put into place in the cavity 9 of the housing 2 in removable manner.

One or more layers 40 of compressible material may be interposed between the filter assembly 3 and the front and rear assemblies 4 and 5, so as to damp any vibration that might appear while the connector 1 is in use.

By way of example, the compressible material can be fluorosilicone.

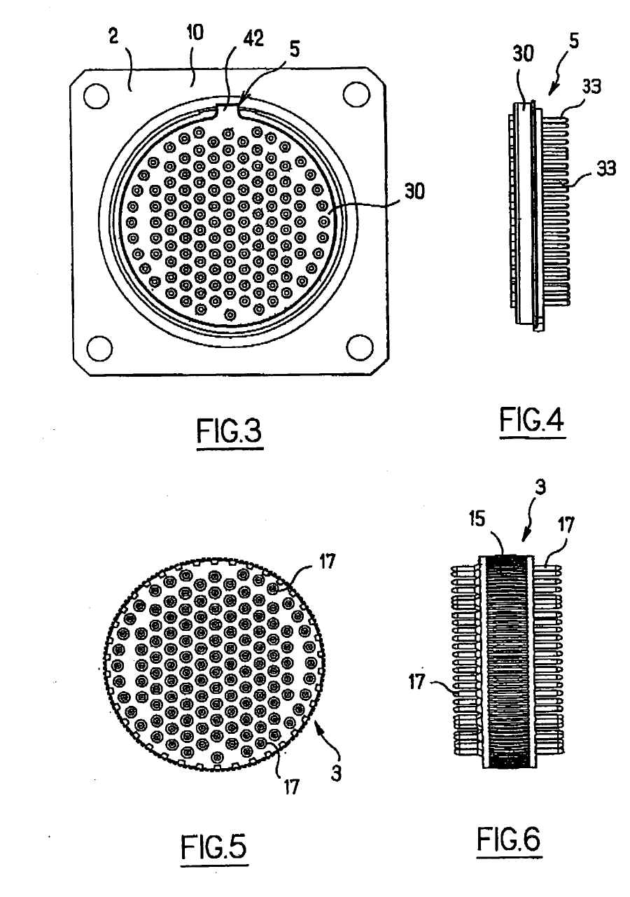

The insert 30 may present a keying portion in relief 42, suitable for co-operating with the housing 2 in such a manner as to prevent the rear assembly 5 from turning relative to the housing 2, as can be seen in FIG. 3.

Naturally, the invention is not limited to the embodiments described above.

The ground belt 15 could be replaced, for example, by elastically deformable tabs distributed all around the filter assembly 3.

1. A filtered electrical connector comprising:
a connector housing comprising front and rear faces and defining at least one cavity opening into the front and rear faces;
a filter assembly configured to be put into place removably in said cavity and comprising a plurality of electrical contact elements, each provided with at least one pin; and
front and rear assemblies configured to be put into place removably in said cavity on either side of the filter assembly so as to protect the filter assembly from the external environment, each of the front and rear assemblies comprising an insulating insert together with electrical contact elements secured to the insulating insert and co-operating with the electrical contact elements of the filter assembly when the connector is assembled, wherein each of the front and rear assemblies comprises at least one contact element provided with a recess in which at least part of the pin of a contact element of the filter assembly is engageable.

2. A connector according to claim 1, wherein at least one of the front and rear assemblies forms a one-piece assembly.

3. A connector according to claim 1, wherein the insert of the front or rear assembly comprises orifices, and wherein at least one of the contact elements of said front or rear assembly is inserted by force into an orifice of the insert.

4. (canceled)

5. A connector according to claim 1, wherein, once the connector is assembled, the contact elements of the filter assembly remain set back from at least one of a rear face of the rear assembly and a front face of the front assembly.

6. A connector according to claim 1, wherein the filter assembly is received entirely within the cavity of the housing once assembly is complete.

7. A connector according to claim 1, wherein at least one of the front and rear assemblies is held against the housing of the connector by at least one of snap-fastening and at least one fitting.

8. A connector according to claim 1, further comprising at least one sealing gasket disposed around at least one of the front and rear assemblies and pressing against a wall of the cavity.

9. A connector according to claim 1, further comprising at least one layer made of a compressible material and interposed between the filter assembly and one of the front and rear assemblies.

10. A connector according to claim 1, wherein the filter assembly comprises a ground element defining at least part of a side wall of the filter assembly and configured to press against a wall of the cavity of the housing.

11. A connector according to claim 10, wherein the ground element comprises an elastically deformable belt.

12. A connector according to claim 1, wherein at least one of the front and rear assemblies comprises a keying element configured to prevent at least one of the front and rear assembly from turning relative to the housing, once assembly has been completed.

13. A connector according to claim 1, wherein the filter assembly comprises filter elements selected from filters of the following types: capacitive; diodes in the form of chips; and Pi type filters.

14. A connector according to claim 1, wherein at least one of the contact elements of the rear assembly is configured to be capable of being soldered to a printed circuit card.

15. A connector according to claim 1, wherein at least one of the contact elements of the rear assembly is configured to enable an electric wire to be soldered thereto.

16. A connector according to claim 1, wherein the contact elements of the front assembly are configured to co-operate with contact elements of a complementary connector.

17-18. (canceled)

19. A connector according to claim 7, wherein the at least one fitting comprises a snag-ring.

20. A connector according to claim 8, wherein the at least one gasket comprises an O-ring.

21. A filtered electrical connector comprising:
a connector housing comprising front and rear faces and defining at least one cavity opening into the front and rear faces;
a filter assembly configured to be put into place removably in said cavity and comprising a plurality of electrical contact elements, each provided with at least one pin;
front and rear assemblies configured to be put into place removably in said cavity on either side of the filter assembly so as to protect the filter assembly from the external environment, each of the front and rear assemblies comprising an insulating insert together with electrical contact elements secured to the insulating insert and co-operating with the electrical contact elements of the filter assembly when the connector is assembled; and
at least one sealing gasket disposed around each of the front and rear assemblies and pressing against a wall of the cavity.
